(19) United States
(12) Patent Application Publication
(10) Pub. No.: US 2016/0193762 A1
(43) Pub. Date: Jul. 7, 2016

(54) PIPE OPENING AND CLOSING DEVICE FOR SUNROOF FRAME INJECTION MOLD

(71) Applicant: CROTECH CO., LTD., Chungcheongnam-do (KR)

(72) Inventor: Min-ho KIM, Seoul (KR)

(21) Appl. No.: 14/912,154

(22) PCT Filed: Aug. 19, 2014
(86) PCT No.: PCT/KR2014/007645

§ 371 Date: Feb. 15, 2016

(30) Foreign Application Priority Data
Aug. 19, 2013 (KR) 10-2013-0097784

(51) Int. Cl. B29C 45/14; B29C 45/26

(52) U.S. Cl. CPC B29C 45/14065; B29C 45/2602; B29L 2031/3005

(57) ABSTRACT

A pipe opening and closing device includes a fixed body fixed inside the injection mold, upper and lower supports on a top surface and a bottom surface of the fixed body to linearly move forward and backward, a movable body coupled to rear end parts of the upper and lower supports to linearly move the upper and lower supports forward and backward and at the same time, while moving forward and backward, and upper and lower holders on front upper and lower sides of the fixed body to move up and down and having, on surfaces that face each other, pipe insertion parts into which the wire pipe end part is inserted, wherein the upper and lower holders are separated from or come into close contact with each other by moving up or down in opposite directions according to the linear forward and backward movements of upper and lower supports.

### TECHNICAL FIELD

The present invention relates to a pipe opening and closing device for a sunroof frame injection mold, and more particularly to a pipe opening and closing device for a sunroof frame injection mold, capable of injection-molding sun roof frames having various shapes.

### BACKGROUND ART

In general, as shown in FIG. 8, a wire pipe P, which surrounds a driving wire moving forward and backward by an electric motor, is integrally formed with a sunroof frame F, in order to open and close a door and operate a deflector.

According to a conventional scheme of including the wire pipe P in the sunroof frame F, after performing an injection-molding work to form a fitting groove used to fit the wire pipe into the sunroof frame F, the wire pipe is fitted into the fitting groove additionally formed in the sunroof frame and assembled with the sunroof frame.

However, in the assembling manner, since the wire pipe may be individually assembled by a manual work after the injection-molding work of the frame, the manufacturing process becomes complicated, and the manufacturing time is significantly required. In addition, the gap is formed between the fitting groove and the wire pipe due to the assembling structure in which the wire pipe is fitted into the fitting groove. Accordingly, noise may be caused as the wire pipe is trembled in high-rate driving.

In addition, for example, as suggested through Korean Patent Publication No. 10-2009-0094954, which is a prior art, as a conventional scheme, melting resin is injected into a mold-groove part of an injection-mold in the state that the wire pipe is fixed to the injection-mold by an additional pipe fixing device, thereby injection-molding the sunroof frame integrated with the wire pipe P. As described above, in the case of a scheme of injecting-molding the frame F integrated with the wire pipe P, the problems of the above assembling scheme may be solved.

However, when an end portion of the wire pipe P protrudes from an outer portion of the sunroof frame F as shown in an enlarged view of FIG. 8, or the peripheral part of the end portion of the wire pipe P has a specific asymmetrical shape that is not vertically symmetrical, it is difficult to injection-mold the wire pipe P integrated with the sunroof frame F in the structure of simply fixing the wire pipe P to the injection-mold.

In other words, in this case, a component to close the end portion of the wire pipe P or to occupy a space in a specific shape is required in one of a pair of left and right molds of the injection-mold. If the component is formed at one side of the injection-mold, when the left and right molds are spread, and the sunroof frame F, which is injection-molded, is pushed to be separated from the mold after the injection-molding work, the wire pipe 2 is locked to the component, so that the injection-molding may be not smoothly performed.

### DISCLOSURE

### Technical Problem

The present invention is made to solve the problems occurring in the art, and an object of the present invention is to provide a pipe opening and closing device for a sunroof frame injection mold, which is fixed to the injection mold to close an end portion of a wire pipe fixed to the injection-mold in injection-molding and opening the wire pipe when the sunroof frame is separated from the injection-mold, so that sunroof frames having various shapes can be easily injection-molded.

### Technical Solution

In order to accomplish the above object, there is provided a pipe opening and closing device for a sunroof frame injection mold, which is mounted in an injection-mold for molding a sunroof frame to selectively close an end portion of a wire pipe of the sunroof frame. The pipe opening and close device includes a fixed body fixed to an inside of the injection-mold, upper and lower supports provided on top and bottom surfaces of the fixed body, respectively, such that the upper and lower supports are linearly moved forward and backward, respectively, a moving body fixedly coupled to rear end portions of the upper and lower supports, respectively, to move forward and backward while linearly moving the upper and lower supports forward and backward, and upper and lower holders provided movably up and down at front upper and lower portions of the fixed body, respectively, and provided in mutually facing surfaces thereof with pipe fitting parts, into which an end portion of the wire pipe is fitted, to be moved up and down in opposition directions to each other while being separated from each other or coming into close contact with each other as the upper and lower supports are linearly moved forward and backward.

In this case, at a front lower portion of the upper support and at an upper portion of the upper holder, upward inclination surfaces, which are upwardly inclined in a forward direction, are formed, and rail parts are mutually slidably formed, such that the upper holder is moved down or up as the upper support is moved forward or backward, and, at a front upper portion of the lower support and at a lower portion of the lower holder, downward inclination surfaces, which are downwardly inclined in the forward direction, are formed, and rail parts are mutually slidably formed, such that the lower holder is moved up or down as the lower support is moved forward or backward.

### Advantageous Effects

As described above, according to the pipe opening and closing device for the sunroof frame,

Since the upper and lower holders selectively close and restrict the end portion the wire pipe through a sliding type operation, the sunroof frames having various shapes and structures can be easily injection-molded without restriction on the length of the exposed end portion of the wire pipe or on the shapes of peripheral portions of the exposed end portion of the wire pipe.

In addition to the above effects, which are apparently indicated, unique effects easily predictable from the features of the present invention are in the effects produced according to the present invention.

### DESCRIPTION OF DRAWINGS

FIG. 1 is a perspective view showing a pipe opening and closing device for a sunroof frame injection mold according to one embodiment of the present invention.

FIG. 2 is a side view showing the pipe opening and closing device for the sunroof frame injection mold according to one embodiment of the present invention.

FIG. 3 is a side view showing an upper holder separated from a lower holder as a movable body is moved backward in FIG. 2.

FIG. 4 is a front view showing the injection-mold having the pipe opening and closing device according to the present invention installed therein, in which the upper holder is separated from the lower holder.

FIG. 5 is a side view showing the injection mold having the pipe opening and closing device according to the present invention installed therein, in which the upper holder is separated from the lower holder.

FIG. 6 is a front view of the injection mold having the pipe opening and closing device according to the present invention installed therein, in which the upper holder closely makes contact with the lower holder.

FIG. 7 is a side sectional view showing the injection mold having the pipe opening and closing device according to the present invention installed therein, in which the upper holder closely makes contact with the lower holder.

FIG. 8 is a view showing one example of a sunroof frame.

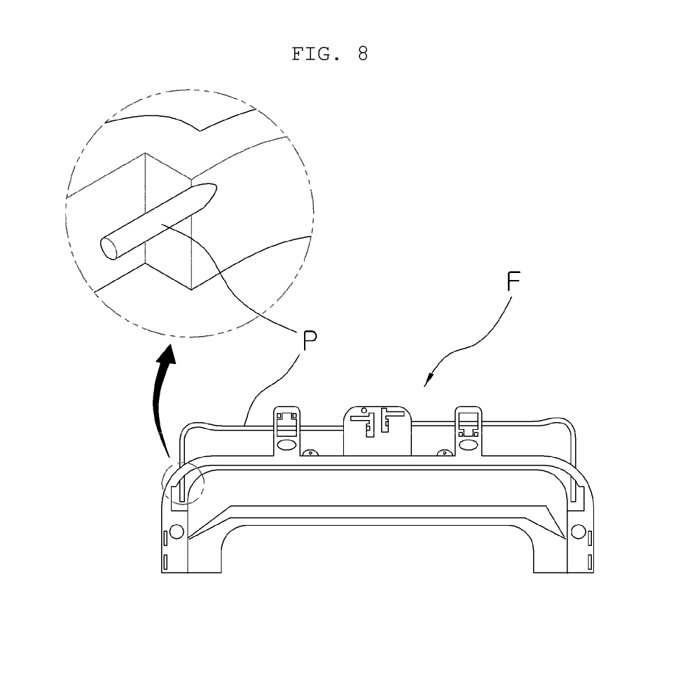

### BEST MODE

### Mode for Invention

Hereinafter, a pipe opening and closing device for a sunroof frame injection mold according to an exemplary embodiment of the present invention will be described in detail with reference to accompanying drawings.

Since the present embodiment is provided for those skilled in the art so that those skilled in the art can completely understand the present invention. The shape, the size, and the interval between elements may be exaggerated or down-sized.

Further, in the following description, if a component is “installed in”, “fixed to” or “coupled to” another component, the component may be directly installed in, fixed to, or coupled to another component, and one or more intervening layers may be present.

In addition, the detailed descriptions of well-known techniques incorporated herein may be omitted when they make the subject matter rather unclear.

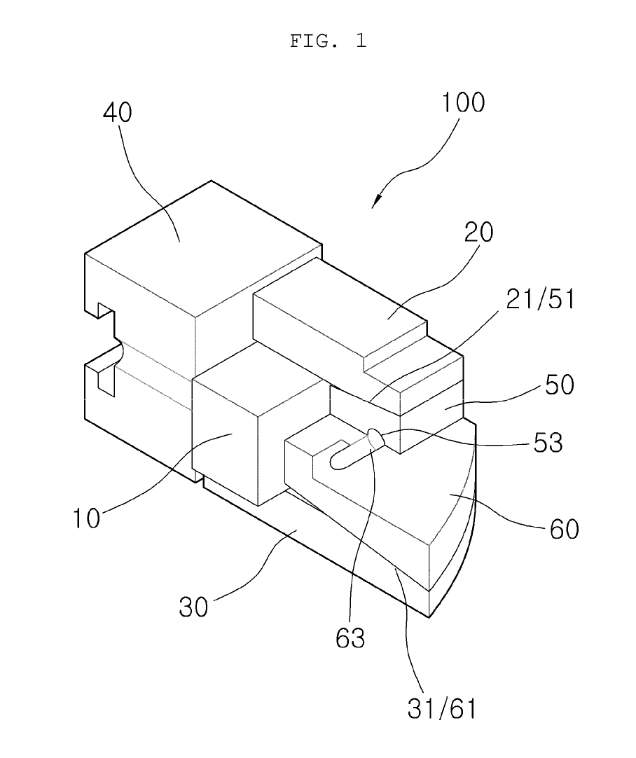

FIGS. 1 to 7 are views showing a pipe opening and closing device for a sunroof frame injection mold (pipe opening and closing device) according to an exemplary embodiment of the present invention. The pipe opening and closing device according to one embodiment of the present invention may include a fixed body 10, a movable body 20, an upper support 30, a lower support, an upper holder 50, and a lower holder 60 with reference to the drawings.

The fixed body 10 is fixedly installed inside an injection-mold M to mold the sunroof frame.

The upper support 20 and the lower support 30 are provided on a top surface and a bottom surface of the fixed body 10, respectively, in parallel. In addition, the upper and lower supports 20 and 30 are provided linearly movably forward and backward with respect to the fixed body 10.

The upper and lower supports 20 and 30 linearly move forward and backward along the top and bottom surfaces of the fixed body 10 while moving up and down the upper and lower holders 50 and 60 in opposite directions.

To this end, an upward inclination surface 21, which is inclined upwardly in a forward direction, is formed at a front lower portion of the upper support 20, and a downward inclination surface 31, which is inclined downwardly in the forward direction, is formed at the front upper portion of the lower support 20.

The moving body 40 is provided at a rear portion of the fixed body 10 to move forward and backward with respect to the fixed body 10.

In addition, the moving body 40 is fixedly coupled to rear end portions of the upper and lower supports 20 and 30, respectively. Therefore, as the moving body 40 is moved forward and backward, the upper support 20 and the lower support 30, which are coupled at front of the pipe opening and closing device, are linearly moved forward and backward at the same time.

The moving body 40 may be configured to be coupled to a driving unit which is additionally installed in the injection-mold M and moved forward and backward according to the operations of the driving unit. The driving unit may include a hydraulic cylinder S.

The upper holder 50 and the lower holder 60 are provided at front upper and lower portions of the fixed body 10 to be moved up and down, respectively.

The upper holder 50 and the lower holder 60 are provided in facing surfaces, that is, bottom and top surfaces of the upper holder 50 and the lower holder 60 thereof with pipe fitting parts 53 and 63 allowing an end portion of the wire pipe P to be fitted therein and closed when the upper holder 50 closely makes contact with the lower holder 60. In addition, the whole shapes of the upper and lower holders 50 and 60 may be variously formed depending on peripheral shapes of the wire pipe P.

The upper and lower holders 50 and 60 operate as the upper support 20 and the lower support 30 are linearly moved forward and backward so that the upper and lower holders 50 and 60 are moved up and down in opposition directions to each other with respect to the fixed body 10.

To this end, an upward inclination surface 51, which is upwardly inclined in the forward direction, is formed at an upper portion of the upper holder 50 corresponding to the upward inclination surface 21 of the upper support 20, and a downward inclination surface 61, which is downwardly inclined in the forward direction, is formed at a lower portion of the lower holder 50 corresponding to the down inclination surface 31 of the lower support 30.

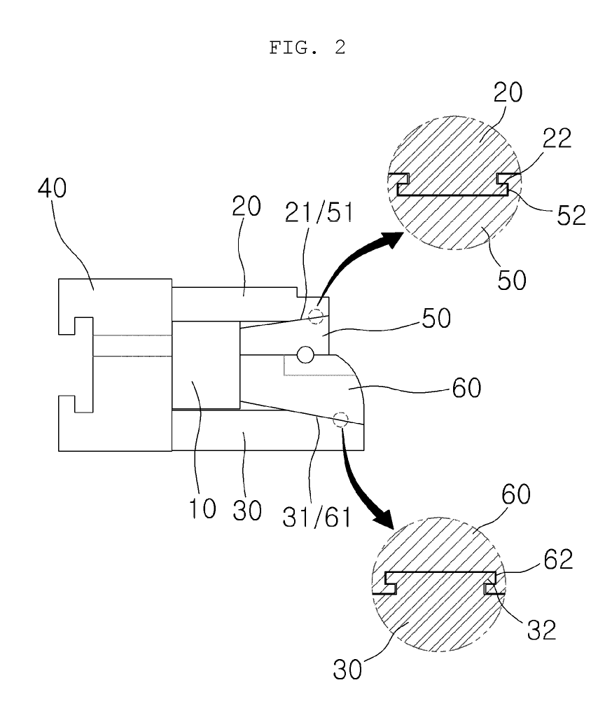

Rail parts are formed on the mutually corresponding upward inclination surfaces 21 and 51 of the upper support 20 and the upper holder 50. In other words, as shown in the enlarged view of FIG. 2, a rail groove 52 may be formed in the upward inclination surface 51 of the upper holder 50, and a rail protrusion 22 may be formed at the upward inclination surface 21 of the upper support 20 so that the rail protrusion 22 is fitted into the rail groove 52 to be slid.

Similarly, rail parts including a rail groove 62 and a rail protrusion 32, which are mutually slidable, may be formed on the mutually corresponding down inclination surfaces 61 and 31 of the lower holder 60 and the lower support 30.

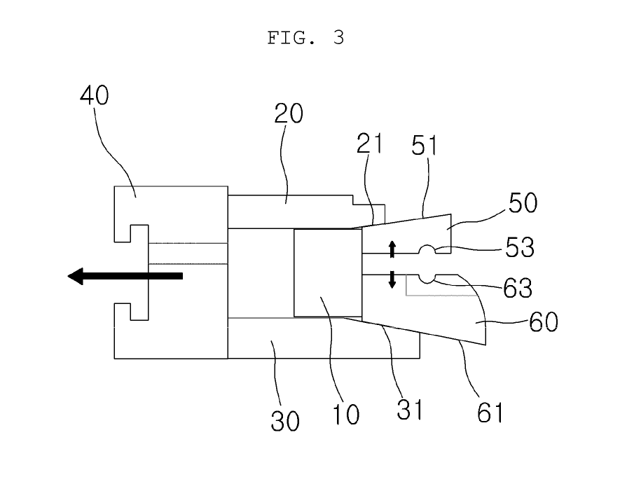

Through the above configuration, as shown in FIG. 3, when the upper support 20 and the lower support 30 are moved backward, the upper holder 50 slides along the rail parts on the upward inclination surfaces 21 and 51 while being moved up, and the lower holder 60 slides along the rail parts on the down inclination surfaces 31 and 61 while being moved down. Accordingly, the upper holder 50 is separated from the lower holder 60, so that the pipe fitting grooves 53 and 63 formed in the upper holder 50 and the lower holder 60, respectively, are spread and open.

On the contrast, as shown in FIG. 2, when the upper support 20 and the lower support 30 are moved forward, the upper holder 50 slides along the rail part on the upward inclination surfaces 21 and 51 while being moved down, and the lower holder 60 slides along the rail part on the downward inclination surfaces 31 and 61 while being moved up. Therefore, the upper holder 50 comes into close contact with the lower holder 60, so that the pipe fitting parts 53 and 63, which have been open, are closed.

Hereinafter, the operation of the present invention having the above configuration will be described briefly.

The pipe opening and closing device 100 according to the present invention is mounted in one of a pair of left and right molds of the injection-mold M used to injection-mold the sunroof frame for the operation thereof.

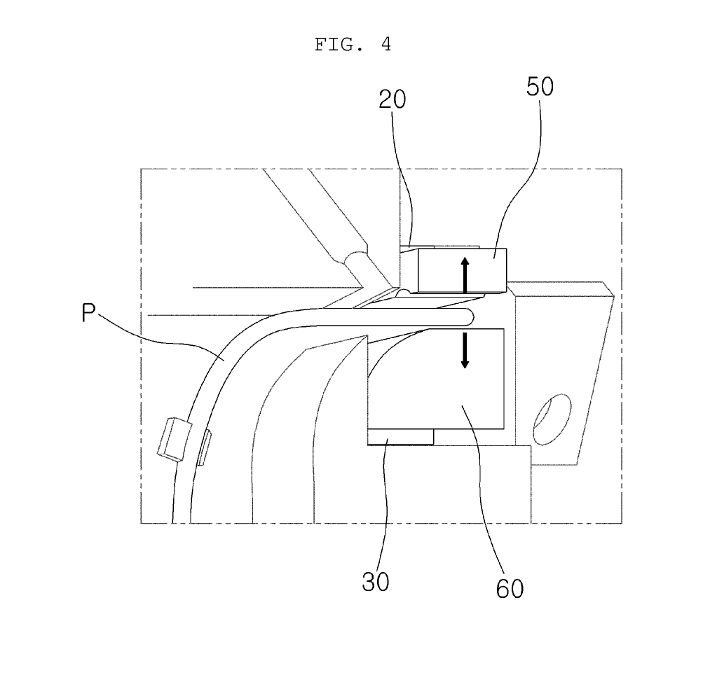

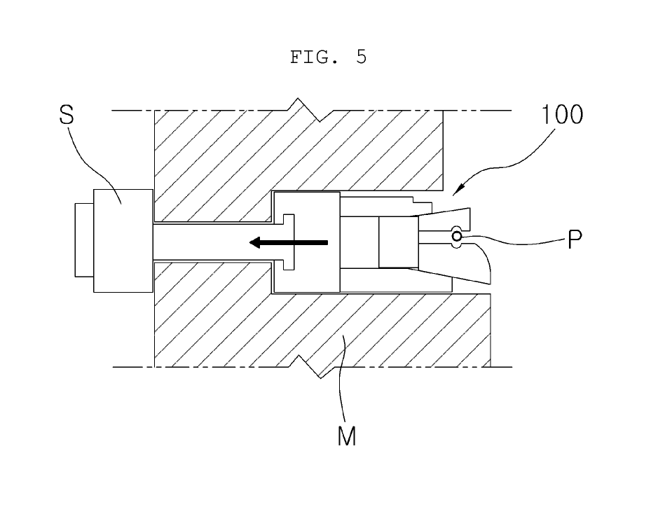

As shown in FIGS. 4 and 5, in the state that left and right molds are open (mold open state), the wire pipe P is fitted into one mold M. In this case, the moving body 40 is moved backward and separated from the fixed body 10. The upper holder 50 is moved up and the lower holder 60 is moved down, so that the upper holder 50 and the lower holder 60 are spread with respect to each other so that the pipe fitting parts 53 and 63 become open.

In this state, when the wire pipe P is mounted at one mold, the end portion of the wire pipe P is located in the pipe fitting parts 53 and 63 that are in an open state as shown in FIG. 4. If the end portion of the wire pipe P is located, the hydraulic cylinder S, which serves as a driving unit, is operated, so that the moving body 40 is moved forward toward the fixed body 10.

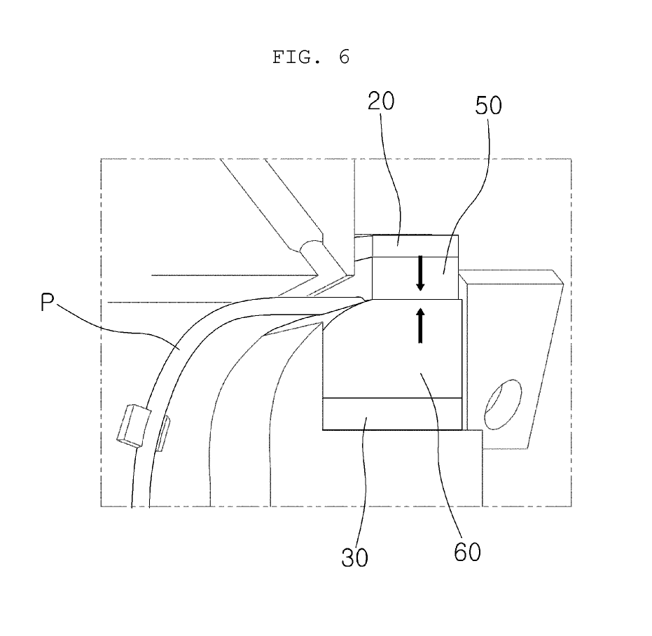

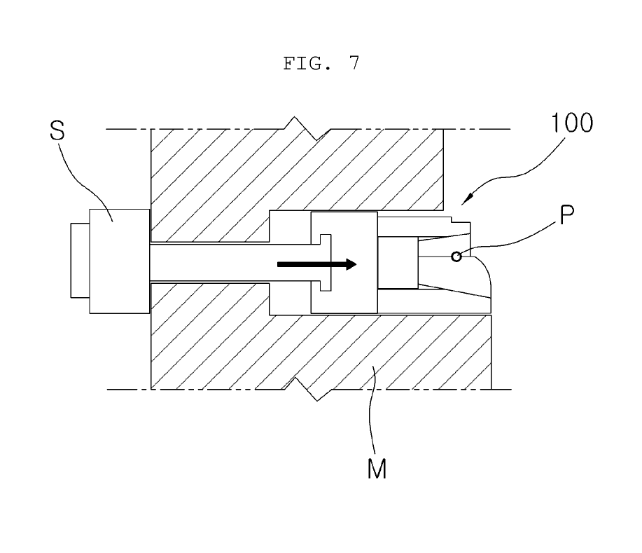

As the moving body 40 is moved forward, the upper support 20 and the lower support 30 fixed on the moving body 40 are simultaneously moved forward above and under the fixed body 10. Simultaneously, the upper holder 50 and the lower holder 60, which are vertically separated from each other, are moved down and up in opposition directions to each other along the upward inclination surface 21 of the upper support 20 and the downward inclination surface 31 of the lower support 30, so that the upper holder 50 comes into close contact with the lower holder 60. Accordingly, as shown in FIGS. 6 and 7, the pipe fitting grooves 53 and 63, which are spread, close the end portion of the wire pipe P.

After the wire pipe P has been closed in the pipe fitting parts 53 and 63 of the upper holder 50 and the lower holder 60, the opposite mold is moved so that the pair of left and right molds are closed (Mold close state). In this state, a melting rein is injected into the molds to injection-mold the sunroof frame.

In addition, after the injection-molding work has been finished, a push rod of one mold pushes the sunroof frame to open the mold. If the sunroof frame is pushed in the state that the wire pipe P is closed due to the close contact between the upper holder 50 and the lower holder 60, the end portion of the wire pipe is closed and restricted, so that the wire pipe P may be broken.

Accordingly, the pneumatic cylinder S is re-operated before the mold opening process, so the moving body 40, which has been moved forward, is moved backward again, so that an opposite procedure to the above-described closing process is performed to separate the upper holder 50 and the lower holder 60 from each other upward and downward. Accordingly, the pipe fitting parts 53 and 63, which are in a close state, are spread and open.

After the pipe fitting parts 53 and 63 have been open, the wire pipe P is not restricted by any part, so that the sunroof frame integrated with the wire pipe P can be safely separated from one mold by the push rod while the mold being open, thereby completing the injection-molding work.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A pipe opening and closing device for a sunroof frame injection mold, which is mounted in an injection-mold for molding a sunroof frame to selectively close an end portion of a wire pipe of the sunroof frame, the pipe opening and close device comprising:
a fixed body fixed to an inside of the injection-mold;
upper and lower supports provided on top and bottom surfaces of the fixed body, respectively, such that the upper and lower supports are linearly moved forward and backward, respectively;
a moving body fixedly coupled to rear end portions of the upper and lower supports, respectively, to move forward and backward while linearly moving the upper and lower supports forward and backward simultaneously; and
upper and lower holders provided movably up and down at front upper and lower portions of the fixed body, respectively, and provided in mutually facing surfaces thereof with pipe fitting parts, into which an end portion of the wire pipe is fitted, to be moved up and down in opposition directions to each other while being separated from each other or coming into close contact with each other as the upper and lower supports are linearly moved forward and backward.

2. The pipe opening and closing device of claim 1, wherein, at a front lower portion of the upper support and at an upper portion of the upper holder, upward inclination surfaces, which are upwardly inclined in a forward direction, are formed, and rail parts are mutually slidably formed, such that the upper holder is moved down or up as the upper support is moved forward or backward, and
wherein, at a front upper portion of the lower support and at a lower portion of the lower holder, downward inclination surfaces, which are downwardly inclined in the forward direction, are formed, and rail parts are mutually slidably formed, such that the lower holder is moved up or down as the lower support is moved forward or backward.

3. An injection-mold for molding a sunroof frame, comprising the pipe opening and closing device of claim 1.
